(19) United States
(12) Patent Application Publication
(10) Pub. No.: US 2011/0260941 A1
(43) Pub. Date: Oct. 27, 2011

(54) WIDEBAND RADIATING ELEMENTS

(75) Inventors: Bevan B. Jones, North Epping NSW (AU); Peter J. Liversidge, Glenbrook NSW (AU); Ozgur Isik, Drummoyne NSW (AU)

(73) Assignee: Argus Technologies (Australia) Pty Ltd., Bella Vista (AU)

(21) Appl. No.: 13/087,197

(22) Filed: Apr. 14, 2011

Related U.S. Application Data
(63) Continuation-in-part of application No. PCT/AU2009/001343, filed on Oct. 12, 2009.

(30) Foreign Application Priority Data
Oct. 15, 2008 (AU) 2008905334
Feb. 24, 2011 (AU) 2011900647

(51) Int. Cl. H01Q 13/00; H01Q 21/06

(52) U.S. Cl. 343/776; 343/772

(57) ABSTRACT

Wideband radiating elements, methods of transmitting and receiving signals using a wideband radiating element, standalone antennas, and array antennas are disclosed. The wideband radiating element (antenna) has wide bandwidth for a relatively constant beamwidth and comprises a section of waveguide, a patch radiator, and one or more tuned loops. The wideband radiating element may comprise: a section of waveguide, at least one dipole antenna element, and at least one tuned circuit. Each dipole antenna element is disposed within the waveguide section as a feed for the waveguide section.

### CROSS-REFERENCE TO RELATED APPLICATIONS

This application is a continuation-in-part application of prior International (PCT) Patent Application No. PCT/AU2009/001343 filed on 12 Oct. 2009 in the name of Argus Technologies (Australia) Pty Ltd et al., which claims the benefit of Australian Provisional Patent Application No. 2008905334 filed on 15 Oct. 2008 in the name of Argus Technologies (Australia) Pty Ltd, both of which are incorporated by reference herein in their entirety for all purposes. Further, this application claims the benefit of Australian Provisional Patent Application No. 2011900647 filed on 24 Feb. 2011 in the name of Argus Technologies (Australia) Pty Ltd, which is incorporated by reference herein in its entirety for all purposes.

### TECHNICAL FIELD

The present invention relates generally to antennas and in particular to wideband antennas and in particular for such antennas for use base station in wireless telecommunications.

### BACKGROUND

International (PCT) Patent Publication No. WO 2006/135956 published on 28 Dec. 2006 (International Patent Application No. PCT/AU2006/000814 filed on 15 Jun. 2006 filed in the name of Argus Technologies (Australia) Pty Ltd et al) discloses dual-polarized patch antennas having reduced beamwidths. Such a patch antenna comprises a ground plane, a patch radiator, and a feed. The patch radiator is suspended above the ground plane and fed by a central symmetrical loop or by two loops symmetrically disposed about the centre of the patch in a plane normal to the patch between the patch and the groundplane. The feed excites opposite sides of the patch radiator in antiphase.

The radiofrequency spectrum being made available for wireless voice and data services served by basestation antennas is continually increasing. Currently, there is a requirement for up to 50% bandwidth to be achieved with an impedance match of 15 dB. Therefore, a need exists for an improved antenna having wider bandwidth.

### SUMMARY

In accordance with an aspect of the invention, there is provided a wideband radiating element. The wideband radiating element is a wideband patch-fed cavity radiator (antenna) that has wide bandwidth for a relatively constant beamwidth. The wideband radiating element comprises a section of waveguide, a patch radiator, and one or more tuned loops. The waveguide section has a length that is a quarter of a guide wavelength or about a quarter of the guide wavelength, short circuited at one end, and open circuited at the other end to provide a waveguide aperture. The patch radiator is disposed within the waveguide section as a feed for the waveguide section. The one or more tuned loops are coupled to the patch radiator as a feed for the patch radiator in a plane normal to the patch radiator. The width of the waveguide section may be configured to be between about 0.7 wavelengths and about 1.3 wavelengths. Further, the patch radiator is located at a height of 0.125 wavelengths or thereabouts above the short-circuited end of the waveguide section.

The waveguide section may have a cross-section along the longitudinal extent of the waveguide section that is square, rectangular, or circular in form.

The wideband radiating element may further comprise an additional tuning element. The additional tuning element may comprise a dielectric sheet coupled to the waveguide section. The dielectric sheet may be disposed across at least a portion of the waveguide aperture of the waveguide section, or within the waveguide section.

The waveguide section, the patch radiator, and the at least one tuned loop may be configured to radiate over a fifty percent (50%) bandwidth with return loss in excess of 15 dB.

The waveguide section, the patch radiator, and the at least one tuned loop coupled together may provide an equal ripple band-pass filter.

One tuned loop configured as a feed can be used radiate a single polarization, or two tuned loops orthogonally configured as dual polarization feeds can be used to radiate orthogonal polarizations.

The wideband radiating element may further comprise at least one printed circuit board, where a tuned loop is formed on each printed circuit board. Each tuned loop comprises at least one metalised loop, a feed line, and a capacitor coupled in series to the feed line. The feed line may be a microstrip line. The capacitor comprises a section of microstrip or a portion of a coaxial cable.

A stand-alone antenna comprising a wideband radiating element can be implemented, or an array antenna comprising a number of wideband radiating elements can be implemented. The array antenna may be configured as a wideband, cellular base-station antenna array.

In accordance with a further aspect of the invention, there is provided a method of transmitting a signal using a wideband radiating element. The method comprises the steps of: radiating the signal from at least one tuned loop to a patch radiator, the at least one tuned loop in a plane normal to the patch radiator being a feed for the patch radiator; and radiating the signal from the patch radiator disposed within a section of waveguide section as a feed for the waveguide section, the waveguide section having a length that is a quarter of a guide wavelength or about a quarter of the guide wavelength, the waveguide section being short circuited at one end and open circuited at the other end to provide a waveguide aperture.

In accordance with a further aspect of the invention, there is provided a method of receiving a signal using a wideband radiating element. The method comprises the steps of: receiving the signal at the patch radiator disposed within a section of waveguide section, the waveguide section having a length that is a quarter of a guide wavelength or about a quarter of the guide wavelength, the waveguide section being short circuited at one end and open circuited at the other end to provide a waveguide aperture; and receiving the signal at least one tuned loop from a patch radiator, the at least one tuned loop in a plane normal to the patch radiator.

In accordance with an aspect of the invention, there is provided a wideband radiating element, comprising: a section of waveguide having a length that is a quarter of a guide wavelength or about a quarter of the guide wavelength, the waveguide section being short circuited at one end and open circuited at the other end to provide a waveguide aperture; at least one dipole antenna element disposed within the waveguide section as a feed for the waveguide section; and at least one tuned circuit coupled to each respective dipole antenna element as a feed for the dipole antenna element, the tuned circuit comprising at least one transmission line feed and a shunt resonator formed from a segment of transmission line.

The width of the waveguide section may be between about 0.7 wavelengths and about 1 wavelength.

The dipole antenna element may be located at a height of 0.25 wavelengths or about 0.25 wavelengths above the short-circuited end of the waveguide section.

The waveguide section may have a cross-section along the longitudinal extent of the waveguide section that is square, rectangular, or circular in form.

The wideband radiating element may further comprise an additional tuning element.

The additional tuning element may comprise a dielectric sheet coupled to the waveguide section.

The dielectric sheet may be disposed across at least a portion of the waveguide aperture of the waveguide section.

The dielectric sheet may be disposed within the waveguide section.

The waveguide section, the dipole antenna element, and the at least one tuned circuit may be configured to radiate over a fifty percent (50%) bandwidth with return loss in excess of 15 dB.

The waveguide section, the dipole antenna element, and the at least one tuned circuit may be coupled together provide an equal ripple band-pass filter.

The wideband radiating element may comprise one tuned circuit configured to feed a single polarized dipole antenna element, or two tuned circuits orthogonally configured as dual polarization feeds to feed orthogonally polarized dipole antenna elements.

The wideband radiating element may further comprise at least one printed circuit board, a tuned circuit formed on each printed circuit board.

Each tuned circuit may comprise at least one network of metallised components.

The wideband radiating element may comprise: two dipole antenna elements configured orthogonally relative to each other and disposed within the waveguide section as a feed for the waveguide section to radiate orthogonal polarizations; and two tuned circuits each coupled to a respective dipole antenna element as a feed for the respective dipole antenna element, each tuned circuit comprising at least one transmission line feed and a shunt resonator formed from a segment of transmission line.

In accordance with another aspect of the invention, there is provided a stand-alone antenna, comprising a wideband radiating element in accordance with the foregoing aspect.

In accordance with still another aspect of the invention, there is provided an array antenna comprising a plurality of wideband radiating elements, each radiating element in accordance with the foregoing aspect.

The array antenna may be configured as a wideband, cellular base-station antenna array.

In accordance with a further aspect of the invention, there is provided a method of transmitting a signal using a wideband radiating element. The signal is coupled from at least one tuned circuit to at least one dipole antenna as a feed for the dipole antenna element. The tuned circuit comprises at least one transmission line feed and a shunt resonator formed from a segment of transmission line. The signal is radiated from each dipole antenna element disposed within a waveguide section as a feed for the waveguide section. The section of waveguide has a length that is a quarter of a guide wavelength or about a quarter of the guide wavelength. The waveguide section is short circuited at one end and open circuited at the other end to provide a waveguide aperture.

In accordance with a further aspect of the invention, there is provided a method of receiving a signal using a wideband radiating element. The signal is received at least one dipole antenna element disposed within a waveguide section. The section of waveguide has a length that is a quarter of a guide wavelength or about a quarter of the guide wavelength. The waveguide section is short circuited at one end and open circuited at the other end to provide a waveguide aperture. The signal is coupled at least one tuned circuit coupled to the dipole antenna element, the tuned circuit comprising at least one transmission line feed and a shunt resonator formed from a segment of transmission line.

The waveguide section may have a cross-section along the longitudinal extent of the waveguide section that is square, rectangular, or circular in form.

The width of the waveguide section may be between about 0.7 wavelengths and about 1 wavelength.

The dipole antenna element may be located at a height of 0.25 wavelengths or about 0.25 wavelengths above the short-circuited end of the waveguide section.

These and other aspects of the invention are described in detail hereinafter.

### BRIEF DESCRIPTION OF THE DRAWINGS

Embodiments of the invention are described hereinafter with reference to the drawings, in which:

FIG. 1A is a perspective view of a wideband radiating element in accordance with an embodiment of the invention;

FIG. 1B is a perspective view of tuned loops for exciting dual linear polarization using microstrip loops in the wideband radiating element of FIG. 1A;

FIG. 2 is a side elevation view of a wideband radiating element, with a portion of waveguide hidden (shown in cross-section), in accordance with another embodiment of the invention;

FIG. 3 is a side elevation view of a wideband radiating element, with a portion of waveguide hidden (shown in cross-section), in accordance with a further embodiment of the invention;

FIG. 4 is a side elevation view of a wideband radiating element, with a portion of waveguide hidden (shown in cross-section), in accordance with still another embodiment of the invention;

FIG. 5 is a perspective view of a wideband radiating element, i.e., a wideband dipole-fed cavity radiator, shown with one of the two polarization feeds removed for clarity, in accordance with an embodiment of the invention;

FIG. 6 is a perspective view of another wideband radiating element, i.e., a wideband dipole-fed cavity radiator, comprising an isolated dipole antenna element and a waveguide section with the matching feed network omitted for ease of illustration;

FIG. 7 is an S-parameter polar plot showing the optimised impedance match of the dipole/waveguide combination of FIG. 6 (1710 MHz-2690 MHz) from 3D electromagnetic analysis;

FIG. 8 is a perspective view of an example of a waveguide/dipole/feed network combination to achieve wideband impedance matching and stable radiation pattern with frequency (single polarisation only shown); and

FIGS. 9A and 9B are polar and rectangular plots of optimized impedance match using a transmission line and shunt resonator to feed the dipole/waveguide combination, as shown in FIGS. 6 and 7.

### DETAILED DESCRIPTION

Wideband radiating elements, methods of transmitting and receiving signals using a wideband radiating element, standalone antennas, and array antennas are described hereinafter. More particularly the wideband radiating element may be a wideband patch-fed cavity radiator or a wideband dipole-fed cavity radiator. In the following description, numerous specific details, including frequency ranges, cables, dielectric materials, conductive materials, waveguide cross-sectional shapes, and the like are set forth. However, from this disclosure, it will be apparent to those skilled in the art that modifications and/or substitutions may be made without departing from the scope and spirit of the invention. In other circumstances, specific details may be omitted so as not to obscure the invention.

### Wideband Patch-Fed Cavity Radiator

International (PCT) Patent Publication No. WO 2006/135956 published on 28 Dec. 2006 (International Patent Application No. PCT/AU2006/000814 filed on 15 Jun. 2006 filed in the name of Argus Technologies (Australia) Pty Ltd et al), in its entirety, is incorporated herein by reference.

In accordance with the embodiments of the invention, the wideband radiating element is a wideband patch-fed cavity radiator (i.e., an antenna) that comprises a short section of waveguide that is short circuited at one end and open circuited at the other end. The section of waveguide is fed by a patch radiator disposed within the waveguide; in turn, the patch radiator is fed by at least one tuned loop. The tuned loop is disposed in a plane normal to the patch radiator. In this manner, the patch feeds an open waveguide radiator, i.e. the waveguide section. The wideband radiating element can be used to transmit and/or receive signals. The signal can be fed to the tuned loop and radiated from the patch radiator. In turn, the patch radiator is a feed for the waveguide section, which radiates the signal from the wideband radiating element to transmit the signal. Similarly, a signal can be received by the wideband radiating element.

The wideband patch-fed cavity radiator can radiate single or dual linear polarization and is a suitable radiating element for wideband, cellular base-station antenna arrays. Patch radiators are commonly used as radiating elements in cellular base station antennas. Arrays covering UMTS and WiMax/LTE bands (1990 MHz-2750 MHz) have been successfully designed using these radiating elements, but the embodiments of the invention are not limited in application to these particular bands. The resulting radiating element, i.e. the wideband patch-fed cavity radiator, is capable of operating over a fifty percent (50%) bandwidth with return loss in excess of 15 dB. The variation in radiation pattern across this band is relatively small. For example, a cellular base-station panel antenna designed to have a 65° horizontal beamwidth varies in 3 dB beamwidth by less than ±7° over a 46% bandwidth. In the tuned loop, a capacitor or a section of transmission line can be coupled in series to a metalised loop to form a resonating element. One or two tuned loops can be used to obtain a symmetrical feed.

With optimum selection of dimensions, the configuration of the wideband radiating element becomes a three or more resonator filter that can be designed to match the impedance of the input transmission line of a feed to the impedance at the open waveguide radiator. The waveguide section has a length that is a quarter of a guide wavelength or about a quarter of the guide wavelength. The width of the waveguide is typically between 0.7 wavelengths and 1.3 wavelengths. The bandwidth of the resulting radiating element is significantly increased by the waveguide section. The waveguide, suitably dimensioned, also stabilises the radiation pattern, so that there is minimal variation in radiation pattern across the impedance bandwidth.

Optionally, a dielectric body of suitable thickness, physical characteristics, and dielectric constant can be located within the waveguide as a tuning element to provide adjustment of the Q of the open waveguide radiator and can be used to optimise the impedance characteristics across the band of operation.

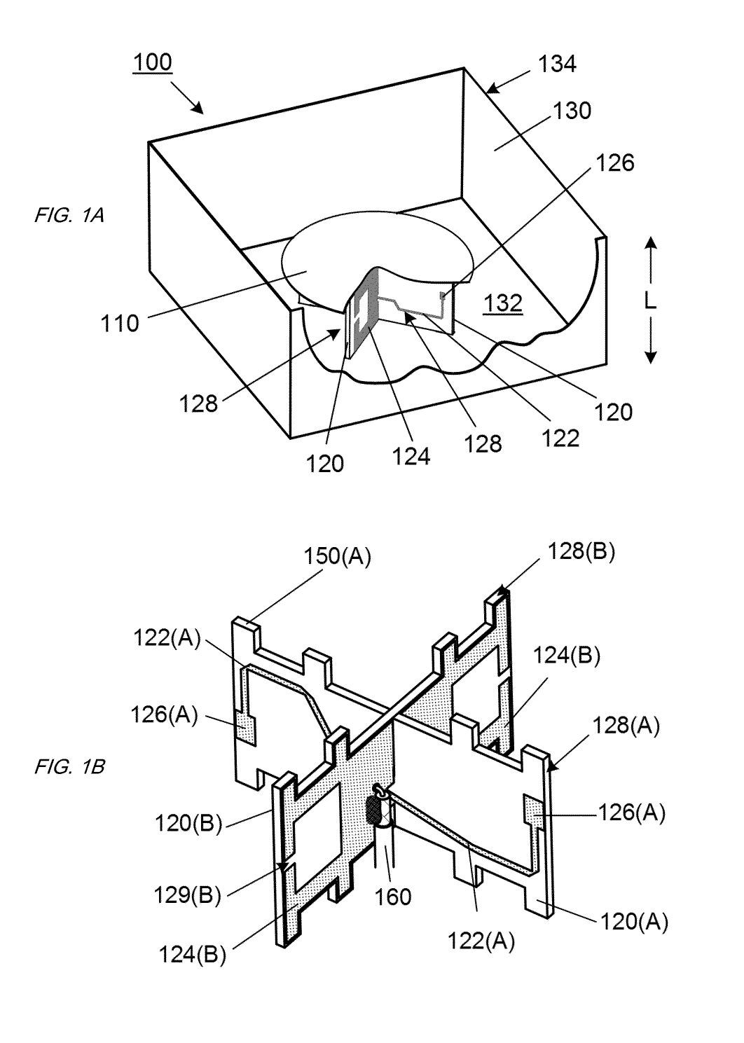

Dual linear polarization can be achieved by means of two orthogonal crossed loops. An equi-ripple impedance response can be achieved by suitably adjusting the resonant frequencies and couplings between the three resonators, namely the tuned loop, the patch and the waveguide section. The wideband radiating element(s) can be used to implement a stand-alone antenna, or an array antenna comprising a number (e.g., 10) of wideband radiating elements as a cellular base-station antenna array. The wideband radiating element provides a relatively constant beamwidth and wide bandwidth. These and other aspects are described hereinafter in greater detail with reference to the embodiments shown in FIGS. 1 to 4.

FIG. 1A is a perspective view of a wideband radiating element, or wideband patch-fed cavity radiator, 100 configured with two orthogonal feeds in accordance with an embodiment of the invention. The wideband radiating element 100 comprises a patch radiator 110, two tuned-loop feeds 128, and a section of waveguide 130. To enable viewing of components of the tuned loops 128 in FIG. 1A, portions of the patch 110 and a wall of the waveguide section 130 are removed in the drawing.

FIG. 1B illustrates, in isolation from other components of the wideband radiating element 100, the two tuned-loop feeds 128(A), 128(B) for exciting dual linear polarization. The printed circuit boards 120 are orthogonally configured relative to each other in a cross- or X-shape when viewed in plan from above. In FIG. 1B, the two tuned loops 128 are differentiated by the parenthetical designations A and B.

Each tuned loop 128 comprises a pair of metalised loops 124 formed on one planar surface of the printed circuit board 120 and microstrip lines 122 and series capacitors 126 are formed on the opposite planar surface of the printed circuit board 120. The microstrip lines 122 and series capacitors 126 are implemented by sections of microstrip in this embodiment. For each tuned loop 128, the microstrip line feeds 122 are configured in antiphase, as best seen on printed circuit board 120(A) in FIG. 1B.

The depicted waveguide section 130 is square in cross-section (viewed from above in plan) and is made of conductive material(s), e.g. metal. The waveguide section 130 can alternatively have a cross-section along the longitudinal extent of the section that is rectangular or circular in form, for example. The waveguide section 130 has a length (L) that is a quarter of a guide wavelength or approximately that length (in a vertical direction as depicted in FIG. 1A). The waveguide section 130 is short circuited at one end 132 (bottom surface) and open circuited at the other end 134 where radiation of the wideband radiating element 100 occurs. The printed circuit boards 120 are fastened or connected to the short circuited portion 132 of the waveguide section 130. As seen best in FIG. 1B, the printed circuit boards have tabs 150 formed on opposite sides of the boards 120. The bottom tabs can be used for interlocking engagement with holes (not shown) formed in the shorted section 132 of the waveguide section 130 and for electrical interconnection with the waveguide section 130. The tabs 150 should be connected to (soldered to) the patch radiator 110 and the shorted section 132 of the waveguide section 130.

The patch radiator 110 is a thin, circular plate or disc made of a conductive material, e.g. metal, but other shapes can be practiced. In this embodiment, the patch radiator 110 is connected to the printed circuit boards 120 on which the loops 124 are formed by interlocking engagement of the tabs 150 shown in FIG. 1B with corresponding holes (not shown) in the patch radiator 110. Electrical interconnection between the loops 124 and the patch radiator 110 is also formed. The patch radiator 110 may be soldered to the printed circuit boards 120. However, in an alternative configuration, the patch radiator 110 may be separately supported for example by plastic posts (not shown). Thus, the patch radiator 110 is suspended above the shorted portion 132 of the waveguide section 130 and is in concentric alignment with the waveguide aperture provided by the open circuited portion 134 of the waveguide section 130. The shorted portion 132 of the waveguide section 130 functions as a groundplane.

The patch radiator is fed by a tuned loop in a plane normal to the patch. In the embodiment of FIG. 1, the patch radiator 110 is fed by two tuned loops 128(A), 128(B) formed on respective printed circuit boards 120 in planes normal to the patch 110. Series resonant circuits are formed by the inductances of the metalised loops 124 with series capacitances implemented as sections of microstrip lines 126. The series capacitance can be implemented in a variety of ways, including as a lumped capacitor or a short section of transmission line, such as coaxial cable or microstrip line.

The tuned loop 128(B) is coupled to a coaxial cable 160 in FIG. 1B and comprises microstrip line feeds 122, the pair of metalised loops 124(B), and the series capacitances 126. For ease of illustration only, the coaxial cable is not depicted in FIG. 1A. The feeds 122 and series capacitances 126 for the tuned loop 128(B) are not shown in FIG. 1B, because those components of the tuned loop 128(B) are on the opposite side of printed circuit board 120(B), which is not visible in FIG. 1B. The counterpart parts 122(A), 126(A) of the other tuned loop 128(A) are visible. Another coaxial cable feed behind the printed circuit board 120(A) is not visible in FIG. 1B. The coaxial cable 160 is used to make an external connection to the radiating element 100. A portion of the outer plastic sheath of the cable 160 is removed to expose the inner conductive shield of the coaxial cable, which is attached (soldered) to the metalisation of the loop 124(B). The centre conductor of the coaxial cable 160 is connected to the microstrip lines 122 (not visible) of the tuned loop 128B on the opposite side through the printed circuit board 120(B).

The patch 110 and the tuned loop(s) 128 form a pair of coupled resonators. This configuration (without the waveguide section 130) can be used as a radiating element. By suitably selecting the characteristics of these resonators and their coupling, a two-resonator filter can be designed to obtain a double-tuned return loss response. The two orthogonal loops 128(A), 128(B) are used to provide a dual-polarised antenna. The two polarizations are radiated across the two diagonals defined by the corners of the square waveguide. Typically a 25-30% impedance bandwidth at 18 dB return loss can be obtained in this way with a patch 110 located at a height of 0.125 wavelengths above a groundplane. Increased height of the patch 110, while increasing bandwidth leads to variation and degradation in the radiation pattern.

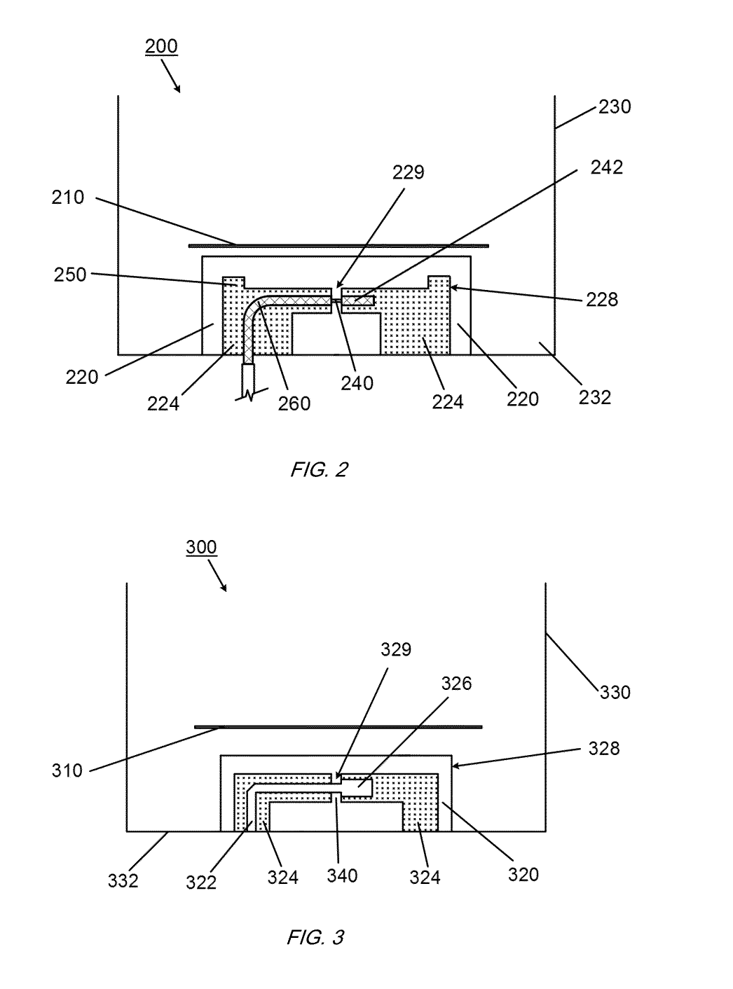

Addition of the waveguide section 130 adds bandwidth, and the additional resonator broadens the bandwidth further. The wideband radiating element 100 may also incorporate one or more tuning elements. The additional tuning element may be, for example, a dielectric sheet (not shown in FIG. 1) coupled to the waveguide section, across at least a portion of the waveguide aperture 134 or within the waveguide section 130. For example, the dielectric sheet may be a solid plastic body, or a plastic body with patterned apertures formed in the body, adapted to fit within the waveguide section or across the waveguide aperture as a cover. Alternatively, pieces of metal may be located in the waveguide for example as etched shapes on printed circuit boards placed in the waveguide. Holes can be formed in the waveguide section 130 (e.g., in the shorted section 132) for external connection to the microstrip line 122 feeding the loops 124. Changes can be made to the embodiment depicted in FIG. 1 to provide additional embodiments of the invention as shown in FIGS. 2 to 4 hereinafter.

FIG. 2 illustrates another wideband radiating element 200, i.e. a wideband patch-fed cavity radiator, with a single tuned-loop feed 128 implemented using a single loop 224 and a transmission line or a coaxial cable 226 (e.g., 50 ohm cable) in accordance with a further embodiment of the invention.

The configurations and details of the patch radiator 210 and the waveguide section 230 are the same as those of the patch radiator 110 and the waveguide section 130 of FIG. 1. The patch radiator 210 may be suspended above the tuned loop 228 by plastic posts (not shown), for example. The tuned loop 228 is formed again in a plane orthogonal to that of the patch radiator 210.

The loop 224 may be implemented as etched cladding on a printed circuit board 220 and is similar in function but different in configuration to the loops 124 of FIG. 1. The printed circuit board 220 is connected or fastened to the shorted section of the waveguide section 230. A portion of the loop 224 is formed using the shorted section 232 of the waveguide 230, and the remainder of the loop 224 is formed by the cladding on the same side of the printed circuit board 220 (facing the viewer in FIG. 2). A small gap 229 is formed in the loop 224. Small tabs 250 are optionally formed in the loop 224. The tabs 250 are useful for adjusting the coupling of the tuned-loop 228 to the patch 210.

The loop 224 is excited across the gap 229. A piece of coaxial cable 260 used to feed the radiating element 200 is brought up one side of the loop 224 (left side in FIG. 2), with the exposed conductive shield connected to that side of the loop 224. This may be done by soldering, for example. The exposed centre conductor 240 of the coaxial cable 260 spans the gap 229 in the loop 224 and is connected to the other side of the loop 224 through a capacitor. The capacitor is implemented as a short open-circuit section 242 of the same cable 260 with its conductive shield connected to the other side of the loop 224. The length of this short section of coaxial cable 242 is selected to resonate with the inductance of the loop 224.

The cable 260 is introduced through a hole in the shorted section 232 of the waveguide section 230. A portion of the external insulator cladding of the cable 260 is shown as white body in FIG. 2.

A single-tuned loop 228 is formed on the printed circuit board 220 for a single polarisation in the embodiment of FIG. 2. However, the wideband radiating element 200 of FIG. 2 can be modified for dual polarisation by the provision of another tuned loop similarly configured on another printed circuit, which can be orthogonally configured relative to the depicted printed circuit board 220.

FIG. 3 illustrates a wideband radiating element 300, i.e. a wideband patch-fed cavity radiator, with a microstrip implementation of a single-tuned loop feed 328 in accordance with yet another embodiment of the invention. This configuration of the wideband radiating element 300 is similar to that of FIG. 2, with the principal difference being the use of microstrip 322, 326 in place of the coaxial cable 260, 242 in FIG. 2.

Again, the configurations of the patch radiator 310 and the waveguide section 330 are the same as those of the patch radiator 110, 210 and the waveguide section 130, 230 of FIGS. 1 and 2. The patch radiator 310 is suspended above a single printed circuit board 320, which can be done using plastic posts (not shown), for example. The tuned loop 328 is formed in a plane orthogonal to that of the patch radiator 310.

A printed circuit board 320 is connected or fastened to the shorted section 332 of the waveguide section 330. In this embodiment, the metalised loop 324 is formed on the rear surface (indicated by dashed lines) of a printed circuit board 320 and has the same function and a similar configuration to the loop 224 of FIG. 2. The optional tabs 250 of FIG. 2 are omitted in this embodiment. A portion of the loop 324 is formed using the shorted section 332 of the waveguide 330. A small gap 329 is formed in the loop 324.

A microstrip track 322 (facing the viewer) is formed on the printed circuit board 320 and is used to feed the loop 324 implemented on the opposite side of the board 320 in FIG. 3. The microstrip track 322 overlays the corresponding portion of the loop 328 formed on the opposite side of the printed circuit board. A short length 340 of the microstrip track 322 extends across the gap 329 in the loop 324. The capacitor 326 is formed of microstrip track on the other side of the loop 324. The microstrip line 322 may be fed from another printed circuit board below the waveguide section 330 through a hole in the shorted section 332 of the waveguide section 330, or alternatively by means of a coaxial cable through a hole in the shorted section 332 of the waveguide section 330, for example. Again, the section 326 of microstrip track 322 to implement the capacitor is selected to resonate with the inductance of the loop 324. Again, while wideband radiating element 300 of FIG. 3 implements a single polarization, this embodiment can be readily modified to implement dual polarization.

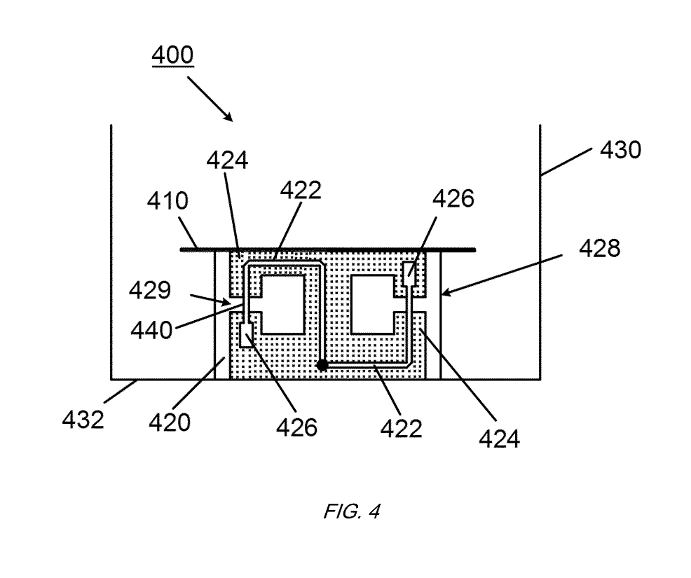

FIG. 4 illustrates a wideband radiating element 400 with a different microstrip implementation having two loops 424 fed in antiphase in accordance with a further embodiment of the invention. Again, the configurations of the patch radiator 410 and the waveguide section 430 are the same as those of the patch radiator 110 and the waveguide section 130 of FIG. 1. In this embodiment, the patch radiator 410 is mounted onto a single printed circuit board 420, which is connected or fastened to the shorted section of the waveguide section 430. This configuration is basically the same as that shown in FIG. 1, but has a single tuned-loop 428 for a single polarization rather than two tuned loops 128(A), 128(B) for dual polarisation.

Two microstrip circuits 422 are formed in antiphase on a planar surface of the printed circuit board 420 to provide the two tuned loops 428, each comprising an inductance and capacitance in series. Two loops 424 with gaps 429 (shown with dotted lines in FIG. 4) are implemented as metallisation on the reverse side of the board 420. Again, short lengths of track 440 extend across the gaps 429 in the loops 424. Series capacitors 426 implemented with microstrip are formed on the other sides of the loops 424. A black dot in FIG. 4 indicates where an external connection (not shown) is made to the microstrip lines 422.

### Wideband Dipole-Fed Cavity Radiator

International (PCT) Patent Publication No. WO 2010/042976 published on 22 Apr. 2010 (International Patent Application No. PCT/AU2009/001343 filed on 12 Oct. 2009 filed in the name of Argus Technologies (Australia) Pty Ltd et al) is incorporated herein by reference.

In accordance with the embodiments of the invention, the wideband radiating element is a wideband dipole-fed cavity radiator comprising: a section of waveguide, one or more dipole antenna elements, and one or more tuned circuits. The waveguide section has a length that is a quarter of a guide wavelength or about a quarter of the guide wavelength. The waveguide section is short circuited at one end and open circuited at the other end to provide a waveguide aperture. Each dipole antenna element is disposed within the waveguide section as a feed for the waveguide section. Each tuned circuit is coupled to a respective dipole antenna element as a feed for the dipole antenna element. The tuned circuit comprises at least one transmission line feed and a shunt resonator formed from a segment of transmission line. The wideband radiating element can be used to transmit and/or receive signals. The signal can be fed to the tuned circuit and radiated from the dipole antenna element. In turn, the dipole antenna element is a feed for the waveguide section, which radiates the signal from the wideband radiating element to transmit the signal. Similarly, a signal can be received by the wideband radiating element.

The wideband dipole-fed cavity radiator can radiate single or dual linear polarization and is a suitable radiating element for wideband, cellular base-station antenna arrays. Dipole antenna elements are commonly used as radiating elements in cellular base station antennas. Arrays covering DCS1800, UMTS and WiMax/LTE bands (1710-2690 MHz.) may use these wideband radiating elements, but the embodiments of the invention are not limited in application to these particular bands. The resulting radiating element, i.e. the wideband dipole-fed cavity radiator, is capable of operating over a fifty percent (50%) bandwidth with return loss in excess of 15 dB. The variation in radiation pattern across this band is relatively small. For example, a cellular base-station panel antenna designed to have a 65° horizontal beamwidth varies in 3 dB beamwidth by less than ±7° over a 57% bandwidth.

With optimum selection of dimensions, the configuration of the wideband radiating element becomes a three resonator filter that can be designed to match the impedance of the input transmission line of a feed to the impedance at the open waveguide radiator. The width of the waveguide section may be between about 0.7 wavelengths and about 1 wavelength. The dipole antenna element may be located at a height of 0.25 wavelengths or about 0.25 wavelengths above the short-circuited end of the waveguide section. The waveguide section may have a cross-section along the longitudinal extent of the waveguide section that is square, rectangular, or circular in form. The bandwidth of the resulting radiating element is significantly increased by the waveguide section. The waveguide, suitably dimensioned, also stabilises the radiation pattern, so that there is minimal variation in radiation pattern across the impedance bandwidth.

Optionally, a dielectric body of suitable thickness, physical characteristics, and dielectric constant can be located within the waveguide as a tuning element to provide adjustment of the Q of the open waveguide radiator and can be used to optimise the impedance characteristics across the band of operation. That is, the wideband radiating element may further comprise an additional tuning element. The additional tuning element may comprise a dielectric sheet coupled to the waveguide section. The dielectric sheet may be disposed across at least a portion of the waveguide aperture of the waveguide section. The dielectric sheet may be disposed within the waveguide section.

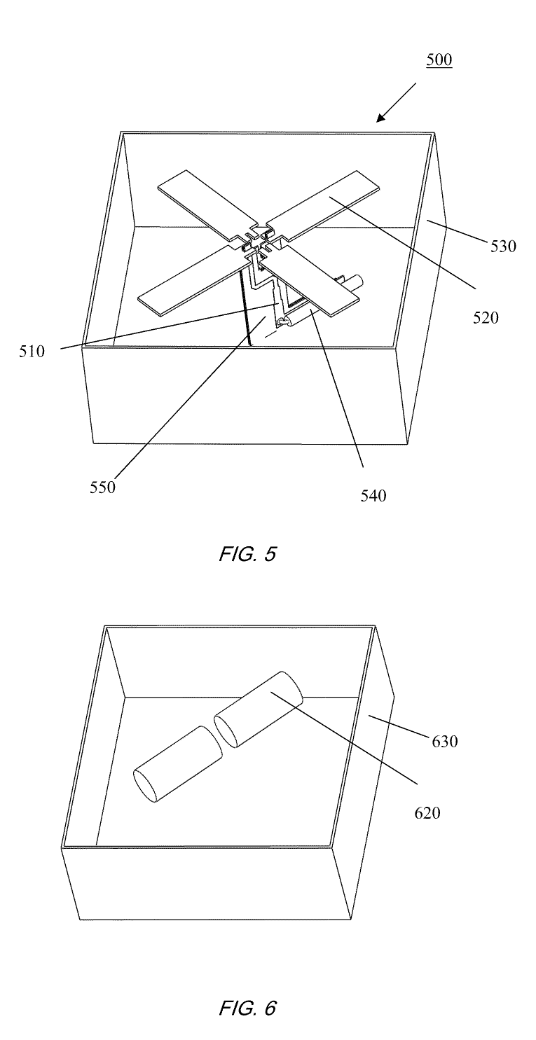

Dual linear polarization can be achieved by means of two orthogonal crossed dipole antenna elements. An equi-ripple impedance response can be achieved by suitably adjusting the resonant frequencies and couplings between the three resonators, namely the tuned circuit, the dipole antenna element and the waveguide section. The wideband radiating element(s) can be used to implement a stand-alone antenna, or an array antenna comprising a number (e.g., 10) of wideband radiating elements as a cellular base-station antenna array. The wideband radiating element provides a relatively constant beamwidth and wide bandwidth. These and other aspects are described hereinafter in greater detail with reference to the embodiments shown in FIGS. 5 to 9.

As shown in FIG. 5, a wideband radiator 500 comprises a short section 530 of waveguide, short circuited at one end and open circuited at the other end where radiation occurs. The waveguide section 530 is fed by one or more dipole antenna elements 520 disposed within the waveguide section 530; in this embodiment there are two dipole antenna elements 520 configured in an orthogonal arrangement. The dipole antenna elements 520 are in turn fed by one or more transmission line sections 510 and one or more shunt resonators 540. Such a radiating element 500 is capable of operating over a 50% bandwidth with return loss in excess of 15 dB, can radiate single or dual linear polarization, and forms a satisfactory radiating element for wideband cellular basestation antenna arrays. The variation in radiation pattern across this band is acceptable for cellular basestation applications.

In the embodiment shown in FIG. 5, the dipole antenna elements 520 are suspended above the shorted section of waveguide 130 on a printed circuit board 550 mounted between the dipole antenna elements 520 and the waveguide section 530. The transmission line sections 510 are implemented on the printed circuit board 550. The shunt resonator 540 is coupled to the transmission line section 510 in FIG. 5 adjacent the shorted section of waveguide 530.

For ease of illustration only a single transmission line section 510 on a printed circuit board 550 with a shunt resonator 540 is shown. This feeds a single dipole antenna element 520. A further transmission line section on another printed circuit board with a shunt resonator is omitted to simplify the diagram. The waveguide section 530, the one or more dipole antenna element 520, and one or more tuned circuit 510 may be configured to radiate over a fifty percent (50%) bandwidth with return loss in excess of 15 dB. The waveguide section 530, the dipole antenna element 520 and the at least one tuned circuit 510 may be coupled together providing an equal ripple band-pass filter. The wideband radiating element 500 may comprise one tuned circuit configured to feed a single polarization dipole antenna element 520, or the wideband radiating element 500 may comprise two tuned circuits orthogonally configured as dual polarization feeds to feed orthogonally polarized dipole antenna elements 520, as shown in FIG. 5. Accordingly, the wideband radiating element 500 may comprise at least one printed circuit board, with a tuned circuit formed on each printed circuit board. Each tuned circuit may comprise one or more sections of transmission line and a single shunt resonator.

Alternatively, each wideband radiating element 500 may comprise at least one tuned circuit feed, with each tuned circuit feed comprising a network of any conductive parts suitably arranged to form one or more transmission line sections and a shunt resonator

The wideband radiating element 500 comprises: two dipole antenna elements 520 configured orthogonally relative to each other and disposed within the waveguide section 530 as a feed for the waveguide section to radiate orthogonal polarizations; and two tuned circuits each coupled to a respective dipole antenna element 520 as a feed for the respective dipole antenna element 520. Each tuned circuit comprises at least one transmission line feed 510 and a shunt resonator 540 formed from a segment of transmission line on a printed circuit board 550. The waveguide section 530 of FIG. 5 has a square cross-section, however, other shapes may be practiced without departing from the scope of the invention.

The possibility of using components other than a printed circuit board to realise the feed network exists. This could be done instead of using a printed circuit board

The method of wideband impedance matching is implemented as follows. Firstly, consider a single-polarization dipole antenna element 620, centrally located within a suitably dimensioned waveguide section 630, as depicted in FIG. 6. The width of the waveguide 630 is normally between 0.7 wavelengths and 1 wavelength, and the length of the waveguide section 630 is normally close to a quarter guide wavelength. On its own without the waveguide component 630, the dipole antenna element 620 displays a single resonance in its impedance response with frequency. The variation of the impedance with frequency of this isolated dipole antenna element 620 is too large to permit operation over a bandwidth useful for wideband cellular basestation antennas. However, if the dipole antenna element 620 is located within the cavity of the waveguide section 630 and the dipole arms are optimized in length to obtain a resonance at the desired frequency, the impedance variation can be greatly reduced, allowing an impedance match over a much wider frequency range to be achieved. The waveguide 630 also stabilizes the pattern so that there is minimal variation in radiation pattern across the impedance bandwidth. Again, the waveguide section 630 is short circuited at one end and open circuited at the other end.

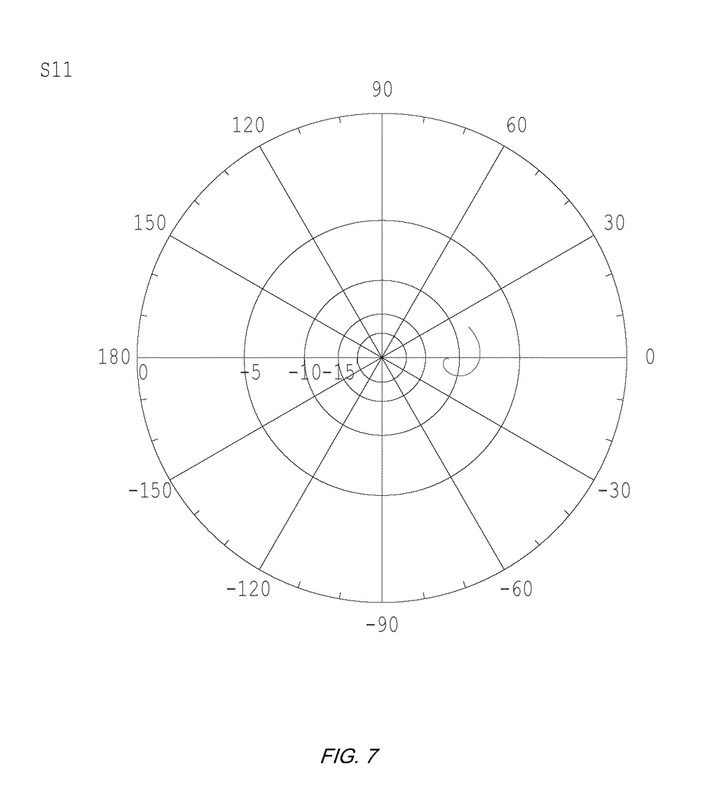

FIG. 7 shows a polar reflection coefficient plot of the dipole/waveguide combination 620, 630 of FIG. 6 after the dipole antenna element 620 and the waveguide section 630 are optimized as described hereinbefore. The plot shows the reflection coefficient for 1.71 GHz to 2.69 GHz. The dual-resonance, wideband nature of the frequency response is evident. On a polar plot such as this, a dipole's frequency response displays a wide arc over a 57% bandwidth. It is difficult to design a compact matching network to transform an arc such as this to the terminating impedance and provide a 15 dB return loss. Instead of this, the polar plot in FIG. 7 shows a dual-resonance response where the single-resonance arc has been transformed into a compact loop, with a much reduced spread of impedance with frequency. To match this combination 620, 630 to the required terminating impedance (typically 50 ohms) and to provide maximum bandwidth, one or more sections of transmission line (not shown in FIG. 6) in combination with a shunt resonator (not shown in FIG. 6) can be used at the feed point of the dipole antenna element 220.

The shunt resonator can also perform the function of a balun, which transforms an unbalanced transmission line feed into a balanced feed as required by the dipole antenna element 620. The transmission line sections act as impedance transformers to bring the impedance of the dipole antenna element 620 to the required terminating impedance. The shunt resonator acts to further reduce the impedance variation with frequency.

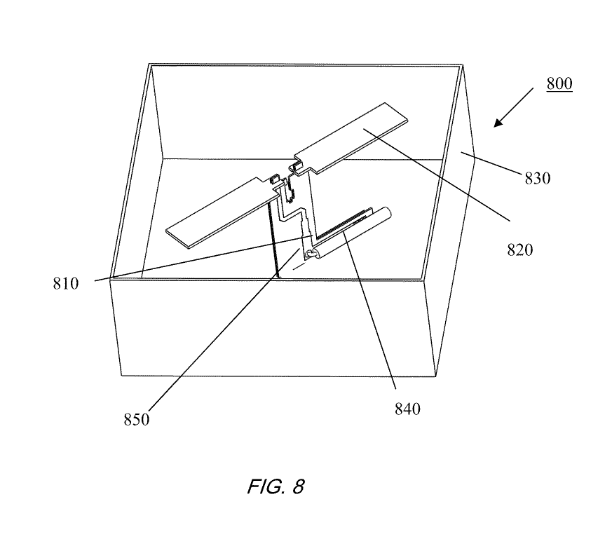

FIG. 8 shows a typical example of such a waveguide/dipole/feed network combination 800, where the feed-network transmission lines 810 and shunt resonator 840 are realized with microstrip tracks on a printed circuit board 850. This figure corresponds to that shown in FIG. 5 except that an extra dipole antenna element 820 is omitted.

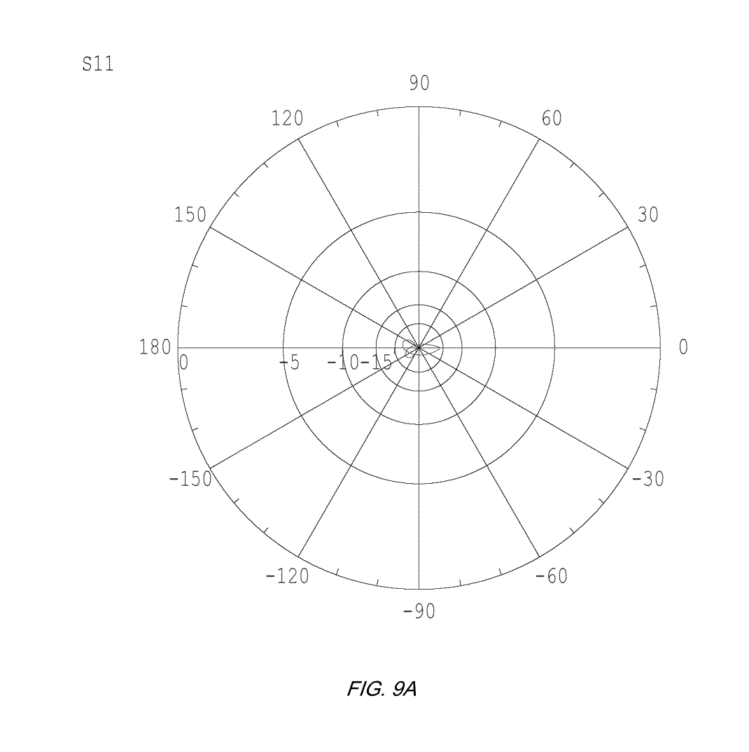

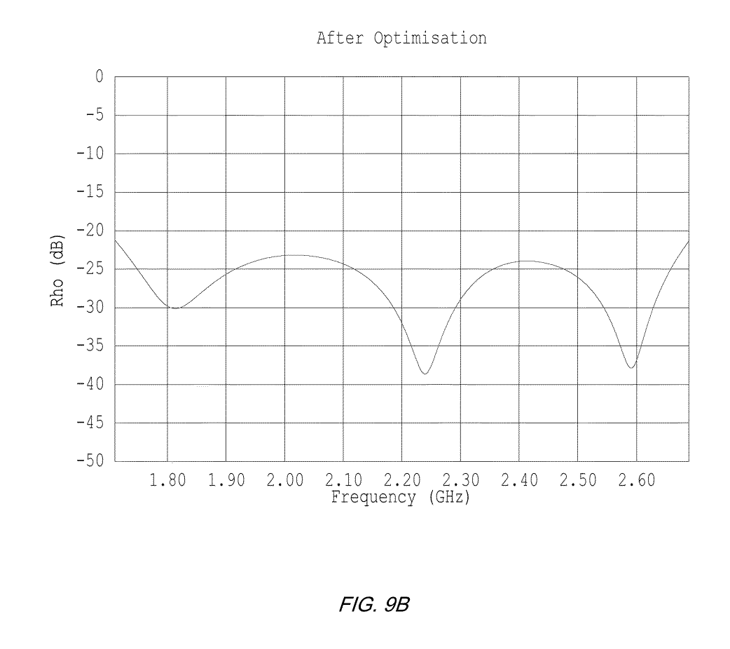

FIG. 9 shows a possible match of the dipole/waveguide represented in FIGS. 6 and 7, achieved after optimization of a feed network comprising a single length of transmission line of approximately ¼ wavelength long in combination with an approximately ¼ wavelength long shunt resonator. A theoretical impedance match of greater than 20 dB return loss can be achieved over a 50% bandwidth with such a matching network. The plots in FIGS. 9A and 9B display the wideband triple-tuned response achieved with this configuration.

Thus, a broadband radiating element has been described comprising a section of waveguide of square, circular, or other cross section, which is approximately a quarter of a guide wavelength in length and is fed by a dipole antenna element. The dipole antenna element is in turn fed by one or more sections of transmission line that are resonated with a shunt section of transmission line. These radiating elements may be used in an array antenna on a ground plane or as a stand-alone antenna. Additional tuning elements such as a dielectric sheet placed across the waveguide aperture or elsewhere in the waveguide may be practiced. Further, wideband radiating elements with dual polarization feeding may be practiced in the form of orthogonal dipoles so as to radiate orthogonal polarizations. The coupling of 3 or more resonant elements may be selected in such a way as to approximate an equal ripple band-pass filter.

In one embodiment of the invention, there is provided a method of transmitting a signal using the foregoing wideband radiating element. The signal is coupled from at least one tuned circuit to at least one dipole antenna as a feed for the dipole antenna element. The tuned circuit comprises at least one transmission line feed and a shunt resonator formed from a segment of transmission line. The signal is radiated from each dipole antenna element disposed within a waveguide section as a feed for the waveguide section. The section of waveguide has a length that is a quarter of a guide wavelength or about a quarter of the guide wavelength. The waveguide section is short circuited at one end and open circuited at the other end to provide a waveguide aperture.

In another embodiment of the invention, there is provided a method of receiving a signal using a wideband radiating element. The signal is received at least one dipole antenna element disposed within a waveguide section. The section of waveguide has a length that is a quarter of a guide wavelength or about a quarter of the guide wavelength. The waveguide section is short circuited at one end and open circuited at the other end to provide a waveguide aperture. The signal is coupled at least one tuned circuit coupled to the dipole antenna element. The tuned circuit comprises at least one transmission line feed and a shunt resonator formed from a segment of transmission line.

The waveguide section has a cross-section along the longitudinal extent of the waveguide section that is square, rectangular, or circular in form.

The width of the waveguide section is between about 0.7 wavelengths and about 1 wavelength.

The dipole antenna element is located at a height of 0.25 wavelengths or about 0.25 wavelengths above the short-circuited end of the waveguide section.

Wideband radiating elements, methods of transmitting and receiving signals using a wideband radiating element, standalone antennas, and array antennas have been described. In view of this disclosure, it will be apparent to one skilled in the art that modifications and/or substitutions may be made without departing from the scope and spirit of the invention.

We claim:

1. A wideband radiating element, comprising:
a section of waveguide having a length that is a quarter of a guide wavelength or about a quarter of the guide wavelength, said waveguide section being short circuited at one end and open circuited at the other end to provide a waveguide aperture;
a patch radiator disposed within said waveguide section as a feed for said waveguide section; and
at least one tuned loop coupled to said patch radiator as a feed for said patch radiator in a plane normal to said patch radiator.

2. The wideband radiating element as claimed in claim 1, wherein the width of said waveguide section is between about 0.7 wavelengths and about 1.3 wavelength.

3. The wideband radiating element as claimed in claim 1, wherein said patch radiator is located at a height of 0.125 wavelengths or thereabouts above said short-circuited end of said waveguide section.

4. The wideband radiating element as claimed in claim 1, wherein said waveguide section has a cross-section along the longitudinal extent of the waveguide section that is square, rectangular, or circular in form.

5. The wideband radiating element as claimed in claim 1, further comprising an additional tuning element.

6. The wideband radiating element as claimed in claim 5, wherein said additional tuning element comprises a dielectric sheet coupled to said waveguide section.

7. The wideband radiating element as claimed in claim 6, wherein said dielectric sheet is disposed across at least a portion of the waveguide aperture of said waveguide section.

8. The wideband radiating element as claimed in claim 6, wherein said dielectric sheet is disposed within said waveguide section.

9. The wideband radiating element as claimed in claim 1, wherein said waveguide section, said patch radiator, and said at least one tuned loop are configured to radiate over a fifty percent (50%) bandwidth with return loss in excess of 15 dB.

10. The wideband radiating element as claimed in claim 1, wherein said waveguide section, said patch radiator, and said at least one tuned loop coupled together provide an equal ripple band-pass filter.

11. The wideband radiating element as claimed in claim 1, comprising one tuned loop configured as a feed to radiate a single polarization.

12. The wideband radiating element as claimed in claim 1, comprising two tuned loops orthogonally configured as dual polarization feeds to radiate orthogonal polarizations.

13. The wideband radiating element as claimed in claim 11, wherein each tuned loop further comprises a capacitor coupled in series to a feed line.

14. The wideband radiating element as claimed in claim 13, wherein said capacitor comprises a section of microstrip or a portion of a coaxial cable.

15. A stand-alone antenna, comprising a wideband radiating element as claimed in claim 1.

16. An array antenna comprising a plurality of wideband radiating elements, each radiating element as claimed in claim 1.

17. The array antenna as claimed in claim 16, configured as a wideband, cellular base-station antenna array.

18. A wideband radiating element, comprising:
a section of waveguide having a length that is a quarter of a guide wavelength or about a quarter of the guide wavelength, said waveguide section being short circuited at one end and open circuited at the other end to provide a waveguide aperture;
at least one dipole antenna element disposed within said waveguide section as a feed for said waveguide section; and
at least one tuned circuit coupled to each respective dipole antenna element as a feed for said dipole antenna element, said tuned circuit comprising at least one transmission line feed and a shunt resonator formed from a segment of transmission line.

19. The wideband radiating element as claimed in claim 18, wherein the width of said waveguide section is between about 0.7 wavelengths and about 1 wavelength.

20. The wideband radiating element as claimed in claim 18, wherein said dipole antenna element is located at a height of 0.25 wavelengths or about 0.25 wavelengths above said short-circuited end of said waveguide section.

21. The wideband radiating element as claimed in claim 18, wherein said waveguide section has a cross-section along the longitudinal extent of the waveguide section that is square, rectangular, or circular in form.

22. The wideband radiating element as claimed in claim 18, further comprising an additional tuning element.

23. The wideband radiating element as claimed in claim 22, wherein said additional tuning element comprises a dielectric sheet coupled to said waveguide section.

24. The wideband radiating element as claimed in claim 23, wherein said dielectric sheet is disposed across at least a portion of the waveguide aperture of said waveguide section.

25. The wideband radiating element as claimed in claim 23, wherein said dielectric sheet is disposed within said waveguide section.

26. The wideband radiating element as claimed in claim 18, wherein said waveguide section, said dipole antenna element, and said at least one tuned circuit are configured to radiate over a fifty percent (50%) bandwidth with return loss in excess of 15 dB.

27. The wideband radiating element as claimed in claim 18, wherein said waveguide section, said dipole antenna element, and said at least one tuned circuit coupled together provide an equal ripple band-pass filter.

28. The wideband radiating element as claimed in claim 18, comprising one tuned circuit configured to feed a single polarized dipole antenna element.

29. The wideband radiating element as claimed in claim 18, comprising two tuned circuits orthogonally configured as dual polarization feeds to feed orthogonally polarized dipole antenna elements.

30. The wideband radiating element as claimed in claim 18, further comprising at least one printed circuit board, a tuned circuit formed on each printed circuit board.

31. The wideband radiating element as claimed in claim 18, wherein each tuned circuit comprises at least one network of metallised components.

32. The wideband radiating element as claimed in claim 18, comprising:
two dipole antenna elements configured orthogonally relative to each other and disposed within said waveguide section as a feed for said waveguide section to radiate orthogonal polarizations; and
two tuned circuits each coupled to a respective dipole antenna element as a feed for the respective dipole antenna element, each tuned circuit comprising at least one transmission line feed and a shunt resonator formed from a segment of transmission line.

33. A stand-alone antenna, comprising a wideband radiating element as claimed in claim 18.

34. An array antenna comprising a plurality of wideband radiating elements, each radiating element as claimed in claim 18.

35. The array antenna as claimed in claim 34 configured as a wideband, cellular base-station antenna array.
